(19) United States
(12) Patent Application Publication
(10) Pub. No.: US 2024/0378463 A1
(43) Pub. Date: Nov. 14, 2024

(54) Enabling High-Quality, Persistent, and Continuously Updating Knowledge for Transformers or LLMs with a Relational Database or Knowledge Graph

(71) Applicant: Cameron Immesoete, Orinda, CA (US)

(72) Inventor: Cameron Immesoete, Orinda, CA (US)

(21) Appl. No.: 18/316,772

(22) Filed: May 12, 2023

(51) Int. Cl. G06N 5/022

(52) U.S. Cl. CPC G06N 5/022

(57) ABSTRACT

Implementations described herein relate to methods, systems, and computer programs that combine Transformers, Large Language Models (LLMs), and/or Generative Pre-Trained Transformers (GPTs) with a Relational Database or Knowledge Graph. By integrating these models with a high-quality information source, such as a Knowledge Graph, the Transformer can generate more accurate, context-aware, and up-to-date responses. The process involves receiving user input, querying the Knowledge Graph for relevant information, updating the Transformer's knowledge with information from the Knowledge Graph, and generating context-aware responses based on the updated knowledge. This integration enhances the performance and relevance of artificial intelligence applications.

### TECHNICAL FIELD

Embodiments relate generally to computer-based generative artificial intelligence and knowledge representation, and more particularly, to methods, systems, and computer-readable media for the integration of Transformer models with Knowledge Graphs for improved artificial intelligence applications.

### BACKGROUND

Some machine learning models, such as Transformers, GPTs, and/or Large Language Models (LLMs), allow input of text, images, videos, 3-D models, pre-tokenized tags, or other files or media to generate context-aware responses. However, these responses may lack up-to-date or accurate information due to the limitations of their training data. In order to provide more accurate and relevant responses, certain methods, systems, and computer-readable media must be created and utilized.

### SUMMARY

According to an aspect, a computer-implemented method of combining a Transformer with a Knowledge Graph for enhanced artificial intelligence applications is provided. The method includes: receiving user input; querying the Knowledge Graph to retrieve relevant information based on the user input; potentially updating the Transformer's knowledge, or cache-like implementation of knowledge, or input context, with information retrieved from the Knowledge Graph; and generating a context-aware and accurate response using the updated LLM.

In some implementations, the method further includes receiving a request for information or assistance from a user; processing the request using the Transformer model; and transmitting the generated response to the user device or generating the output on the user device.

### BRIEF DESCRIPTION OF THE DRAWINGS

FIG. 1 is a system architecture that illustrates the main components of an example system and their interactions. This diagram includes components such as the user device, the LLM, the Knowledge Graph, the query process, the knowledge update process, and the response generation process.

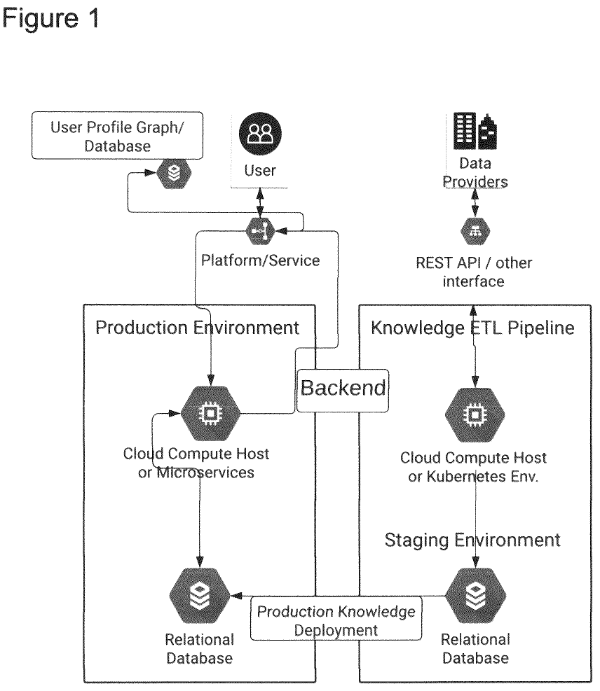

1. A computer-implemented method of combining a Transformer, a Large Language Model (LLM), or a Generative Pre-Trained Transformer (GPT), with a Relational Database, Knowledge Graph, or database otherwise storing knowledge, for enhanced artificial intelligence applications, the method comprising:
a. receiving user input;
b. querying the Knowledge Graph to retrieve relevant information based on the user input;
c. applying the information retrieved from the Knowledge Graph in the Transformer's output; and
d. generating a context-aware and accurate response using the LLM.

2. The computer-implemented method of claim 1, wherein the user input includes one or more of: text, images, videos, 3-D models, pre-tokenized tags, or other files or media.

3. The computer-implemented method of claim 1, wherein the querying of the Knowledge Graph includes performing SQL queries or similar data lookups on the Knowledge Graph, or a subset or index thereof, or parsing the entire Knowledge Graph.

4. The computer-implemented method of claim 1, wherein the Knowledge Graph is updated on a regular basis to ensure the Transformer model has access to up-to-date information.

5. The computer-implemented method of claim 1, further comprising:
a. receiving a request for information or assistance from a user;
b. processing the request using the Transformer model; and
c. transmitting the generated response to the user device responsive to the request or generating the output on the user device.

6. The computer-implemented method of claim 1, wherein the Transformer model, under the hood, writes or updates a local user-specific Knowledge Graph about the user's profile and interests, potentially: privately, only on the user device, leveraging Edge AI.

7. The computer-implemented method of claim 1, wherein the generated response is contextually relevant and adapted to the specific user input and the information retrieved from the Knowledge Graph.

8. The computer-implemented method of claim 1, wherein the generated response may be in the form of text, images, videos, 3-D models, pre-tokenized tags, or other files or media, or a combination thereof.

9. The computer-implemented method of claim 1, wherein the Knowledge Graph is populated with information from various sources, including databases, web pages, books, articles, and other forms of structured or unstructured data.

10. The computer-implemented method of claim 1, wherein the system may be applied to various domains, including but not limited to customer support, virtual personal assistants, content generation, recommendation systems, and natural language processing tasks.

11. The computer-implemented method of claim 1, further comprising monitoring and analyzing user engagement with the generated responses and providing feedback to the Transformer model and Knowledge Graph to improve future response generation and knowledge retrieval.

12. The computer-implemented method of claim 1, wherein the Transformer model and Knowledge Graph are integrated using a variety of techniques, including but not limited to graph embedding, neural network layers, or other forms of information representation and processing.

13. The computer-implemented method of claim 1, wherein the Transformer model may be updated, retrained, or fine-tuned using information from the Knowledge Graph, enabling the Transformer model to adapt its knowledge over time based on the evolving contents of the Knowledge Graph.

14. The computer-implemented method of claim 1, wherein the Transformer model has the ability to update or add information to the Knowledge Graph or a subset or index thereof.
